(19) United States
(12) Patent Application Publication
(10) Pub. No.: US 2018/0017055 A1
(43) Pub. Date: Jan. 18, 2018

(54) SCROLL COMPRESSOR

(71) Applicant: Mitsubishi Electric Corporation, Tokyo (JP)

(72) Inventors: Fumikazu NAGAOKA, Tokyo (JP); Masashi MYOGAHARA, Tokyo (JP); Keisuke NARUMI, Tokyo (JP); Yosuke TSURUOKA, Tokyo (JP)

(21) Appl. No.: 15/538,460

(22) PCT Filed: Apr. 16, 2015
(86) PCT No.: PCT/JP2015/061753

§ 371 Date: Jun. 21, 2017

(51) Int. Cl. F04C 18/02

(52) U.S. Cl. CPC F04C 18/0284; F04C 18/0215; F05C 2251/10

(57) ABSTRACT

A scroll compressor includes a first chamfered portion formed at a distal end potion of a spiral blade of a fixed scroll, a second chamfered portion formed at a distal end portion of a spiral blade of an orbiting scroll, a third chamfered portion formed at a bottom portion of the spiral blade of the fixed scroll, and a fourth chamfered portion formed at a bottom portion of the spiral blade of the orbiting scroll. An expression of 0<{(Av1+Av2)/2}/Ac<1×10⁻⁴ is satisfied where a sectional area of a space between the first chamfered portion and the fourth chamfered portion is defined as Av1, a sectional area of a space between the second chamfered portion and the third chamfered portion is defined as Av2, and a sectional area of a compression chamber is defined as Ac.

### TECHNICAL FIELD

The present invention relates to a scroll compressor configured to prevent leakage of refrigerant gas that is being compressed from a compression chamber.

### BACKGROUND ART

There has been proposed a scroll compressor configured to prevent leakage of refrigerant gas that is being compressed from a compression chamber. For example, there has been proposed a related-art scroll compressor in which a fixed scroll that includes a spiral blade having a spiral shape on a base plate, and an orbiting scroll that includes a spiral blade opposed to the spiral blade of the fixed scroll to be in mesh with the spiral blade of the fixed scroll form a plurality of compression chambers, in which an orbiting motion of the orbiting scroll causes reduction in volume of the compression chamber toward a center of the compression chamber so that compression is performed, in which a chamfered portion is formed at a distal end portion of the spiral blade of the orbiting scroll, and in which a recessed portion is formed at a bottom portion of an outer wall of the spiral blade of the fixed scroll (for example, see Patent Literature 1).

### CITATION LIST

### Patent Literature

Patent Literature 1: Japanese Unexamined Patent Application Publication No.

2012-137000

### SUMMARY OF INVENTION

### Technical Problem

In the scroll compressor disclosed in Patent Literature 1, no suitable dimensional relationship is defined between the chamfered portion formed at the distal end portion of the spiral blade of the orbiting scroll and the recessed portion formed at the bottom portion of the outer wall of the spiral blade of the fixed scroll, that is, at a position opposed to the chamfered portion formed at the distal end portion of the spiral blade of the orbiting scroll. Further, in the scroll compressor disclosed in Patent Literature 1, there is no particular definition for a shape of the distal end portion of the spiral blade of the fixed scroll and a shape of the bottom portion of the outer wall of the spiral blade of the orbiting scroll, that is, a shape at a position opposed to the distal end portion of the spiral blade of the fixed scroll. Consequently, the scroll compressor disclosed in Patent Literature 1 has a problem in that a gap formed between the distal end portion of the spiral blade and the bottom portion of the spiral blade is increased to cause an increase in amount of leakage of the refrigerant gas that is being compressed, increasing leakage loss.

The present invention has been made to solve the above-mentioned problem, and has an object to provide a scroll compressor capable of preventing the leakage of the refrigerant that is being compressed through the gap between the distal end portion of the spiral blade and the bottom portion of the spiral blade, thereby being capable of preventing an increase in leakage loss.

### Solution to Problem

According to one embodiment of the present invention, there is provided a scroll compressor including a fixed scroll including a first base plate portion and a first spiral blade provided to stand on one surface of the first base plate portion, an orbiting scroll including a second base plate portion and a second spiral blade provided to stand on a surface of the second base plate portion opposite to the fixed scroll, and is configured to perform an orbiting motion with respect to the fixed scroll, the first spiral blade and the second spiral blade being in mesh with each other to form a compression chamber, a first chamfered portion formed at each of both corner portions of a distal end portion of the first spiral blade, a second chamfered portion formed at each of both corner portions of a distal end portion of the second spiral blade, a third chamfered portion formed on each of both sides of a bottom portion of the first spiral blade, the third chamfered portion having a same shape as a shape of the second chamfered portion, and a fourth chamfered portion formed on each of both sides of a bottom portion of the second spiral blade, the fourth chamfered portion having a same shape as a shape of the first chamfered portion, in which an expression of 0<{(Av1+Av2)/2}/Ac<1×10⁻⁴ is satisfied, under a state in which, among cross sections of the compression chamber passing through an orbiting center of the orbiting scroll and along a standing direction of the first spiral blade and the second spiral blade, a cross section having a largest sectional area is observed, where a sectional area of a space formed between the first chamfered portion and the fourth chamfered portion under a state in which the first chamfered portion and the fourth chamfered portion are closest to each other is defined as Av1, a sectional area of a space formed between the second chamfered portion and the third chamfered portion under a state in which the second chamfered portion and the third chamfered portion are closest to each other is defined as Av2, and a sectional area of the compression chamber is defined as Ac.

### Advantageous Effects of Invention

In the scroll compressor of an embodiment of the present invention, the shape of the first chamfered portion formed at the distal end portion of the first spiral blade of the fixed scroll and the shape of the fourth chamfered portion formed at the bottom portion of the second spiral blade of the orbiting scroll, that is, the shape at the position opposed to the first chamfered portion are the same. Further, the shape of the second chamfered portion formed at the distal end portion of the second spiral blade of the orbiting scroll and the shape of the third chamfered portion formed at the bottom portion of the first spiral blade of the fixed scroll, that is, the shape at the position opposed to the second chamfered portion are the same. Further, in the scroll compressor of an embodiment of the present invention, the expression of 0<{(Av1+Av2)/2}/Ac<1×10⁻⁴ is satisfied, under a state in which, among cross sections of the compression chamber passing through an orbiting center of the orbiting scroll and along a standing direction of the first spiral blade and the second spiral blade, a cross section having a largest sectional area is observed, where a sectional area of a space formed between the first chamfered portion and the fourth chamfered portion under a state in which the first chamfered portion and the fourth chamfered portion are closest to each other is defined as Av1, a sectional area of a space formed between the second chamfered portion and the third chamfered portion under a state in which the second chamfered portion and the third chamfered portion are closest to each other is defined as Av2, and a sectional area of the compression chamber is defined as Ac. Thus, in the scroll compressor of an embodiment of the present invention, the leakage of the refrigerant that is being compressed through the gap between the distal end portion of the spiral blade and the bottom portion of the spiral blade can be prevented. Consequently, the increase in leakage loss can be prevented. Thus, an embodiment of the present invention is capable of achieving a highly efficient scroll compressor.

### BRIEF DESCRIPTION OF DRAWINGS

FIG. 1 is a vertical sectional view for illustrating a scroll compressor of Embodiment 1 of the present invention.

FIG. 2 is a vertical sectional view for illustrating the vicinity of a compression chamber of the scroll compressor of Embodiment 1 of the present invention.

FIG. 3 is an enlarged view of the part A of FIG. 2.

FIG. 4 is an enlarged view of the part B of FIG. 2.

FIG. 5 is a graph for showing a relationship between Av/Ac and a compressor performance in the scroll compressor of Embodiment 1 of the present invention.

FIG. 6 is an enlarged view for illustrating shapes of relevant parts of the spiral blades in a related-art scroll compressor that is used for calculation of a compressor performance ratio in FIG. 5.

FIG. 7 is a graph for showing a relationship between C1m/H and a compressor performance in the scroll compressor of Embodiment 1 of the present invention.

FIG. 8 is a graph for showing a relationship between Dc1/Ds and the compressor performance in the scroll compressor of Embodiment 1 of the present invention.

FIG. 9 is a vertical sectional view for illustrating the vicinity of a compression chamber of a scroll compressor of Embodiment 2 of the present invention.

FIG. 10 is an enlarged view of the part C of FIG. 9.

FIG. 11 is an enlarged view of the part D of FIG. 9.

### DESCRIPTION OF EMBODIMENTS

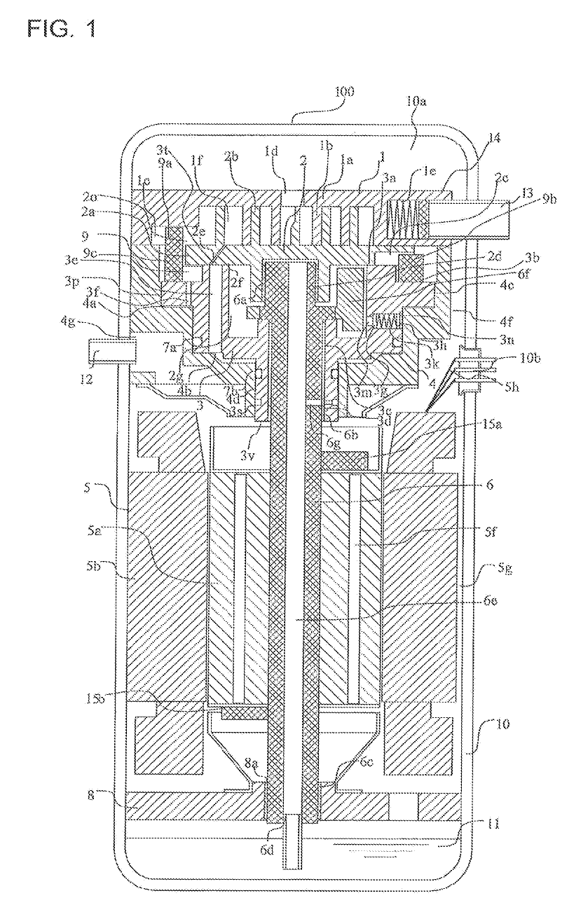

A scroll compressor of Embodiments of the present invention is hereinafter described with reference to the drawings. The scroll compressor of a vertical installation type is described herein as an example. However, the present invention is also applicable to a scroll compressor of a horizontal installation type. Further, the following drawings including FIG. 1 are schematic, and a relationship in sizes of components may be different from the actual relationship.

### Embodiment 1

FIG. 1 is a vertical sectional view for illustrating a scroll compressor of Embodiment 1 of the present invention.

A scroll compressor 100 is configured to suck refrigerant gas circulating in a refrigeration cycle, compress the sucked refrigerant gas into a high-temperature and high-pressure state, and discharge the compressed refrigerant gas. The scroll compressor 100 includes a compression mechanism 14 constructed of a combination of a fixed scroll 1 and an orbiting scroll 2 configured to revolve (orbit) with respect to the fixed scroll 1. Further, the scroll compressor 100 of Embodiment 1 is a hermetic compressor, and the compression mechanism 14 is arranged in a hermetic container 10. In the hermetic container 10, there is also stored an electric motor 5 configured to drive the orbiting scroll 2 connected to a main shaft 6. In the case of the scroll compressor 100 of the vertical installation type, in the hermetic container 10, for example, the compression mechanism 14 is arranged on an upper side, and the electric motor 5 is arranged on a lower side.

The fixed scroll 1 includes a base plate portion 1a and a spiral blade 1b. The spiral blade 1b is a spiral protrusion provided to stand on one surface (lower side in FIG. 1) of the base plate portion 1a. Further, the orbiting scroll 2 includes a base plate portion 2a and a spiral blade 2b. The spiral blade 2b is a spiral protrusion provided to stand on a surface of the base plate portion 2a on a side opposed to the fixed scroll 1 (upper side in FIG. 1). The spiral blade 2b has substantially the same shape as that of the spiral blade 1b. The spiral blade 1b of the fixed scroll 1 and the spiral blade 2b of the orbiting scroll 2 are brought into mesh with each other so that a compression chamber 1f to be relatively changed in volume is geometrically formed.

Herein, the base plate portion 1a corresponds to a first base plate portion of the present invention. The spiral blade 1b corresponds to a first spiral blade of the present invention. The base plate portion 2a corresponds to a second base plate portion of the present invention. The spiral blade 2b corresponds to a second spiral blade of the present invention. Further, when a space formed between the spiral blade 1b of the fixed scroll 1 and the spiral blade 2b of the orbiting scroll 2 communicates with a suction port 1e, the refrigerant gas is sucked into the space as described later. Further, when the space communicates with a discharge port 1d, the refrigerant gas is discharged from the space. Further, under a state in which the space is prevented from communicating with the suction port 1e and the discharge port 1d, the refrigerant gas is compressed in the space. In Embodiment 1, a space formed between the spiral blade 1b of the fixed scroll 1 and the spiral blade 2b of the orbiting scroll 2 in a state in which the space is prevented from communicating with the suction port 1e and the discharge port 1d is referred to as the compression chamber 1f.

An outer peripheral portion of the fixed scroll 1 is fastened to a guide frame 4 by a bolt (not shown). At an outer peripheral portion of the base plate portion 1a of the fixed scroll 1, there is provided a suction pipe 13 configured to guide the refrigerant gas through the suction port 1e to the compression chamber 1f in the space formed between the spiral blade 1b of the fixed scroll 1 and the spiral blade 2b of the orbiting scroll 2. At a center portion of the base plate portion 1a of the fixed scroll 1, there is located the discharge port 1d configured to discharge the refrigerant gas compressed to a high pressure. Then, the refrigerant gas compressed to a high pressure is discharged to an upper portion in the hermetic container 10, that is, to a high-pressure space 10a. The refrigerant gas discharged to the high-pressure space 10a, as described later, passes through a refrigerant flow passage and is discharged through a discharge pipe 12.

With an Oldham mechanism 9 configured to prevent a rotating motion, the orbiting scroll 2 is caused to perform a revolving motion (orbiting motion) with respect to the fixed scroll 1 without performing the rotating motion. A pair of two Oldham guide grooves 1c are formed on a substantially straight line at an outer peripheral portion of the base plate portion 1a of the fixed scroll 1. A pair of two fixed-side keys 9a of the Oldham mechanism 9 are engaged with the Oldham guide grooves 1c to be reciprocally slidable. Further, a pair of two Oldham guide grooves 2c having a phase difference of 90 degrees with respect to the Oldham guide grooves 1c of the fixed scroll 1 are formed on a substantially straight line at an outer peripheral portion of the base plate portion 2a of the orbiting scroll 2. A pair of two orbiting-side keys 9b of the Oldham mechanism 9 are engaged with the Oldham guide grooves 2c to be reciprocally slidable.

With the Oldham mechanism 9 having the configuration described above, the orbiting scroll 2 can perform the orbiting motion (turning motion) without performing rotation. Further, at a center portion of a surface of the orbiting scroll 2 on a side (lower side in FIG. 1) opposite to the surface on which the spiral blade 2b is formed, there is formed an orbiting bearing 2d having a hollow cylindrical shape. In the orbiting bearing 2d, an orbiting shaft portion 6a provided at an upper end of the main shaft 6 is inserted to be rotatable. Further, in the surface of the orbiting scroll 2 on the side (lower side in FIG. 1) opposite to the spiral blade 2b of the base plate portion 2a, there is formed a thrust surface 2f that is slidable and in press-contact with a thrust bearing 3a of a compliant frame 3. Further, in the base plate portion 2a of the orbiting scroll 2, there is formed a gas extraction hole 2e that penetrates through the compression chamber 1f and the thrust surface 2f, and the refrigerant gas that is being compressed is extracted and guided to the thrust surface 2f.

To prevent leakage of the refrigerant gas that is being compressed from the compression chamber 1f, the spiral blade 1b of the fixed scroll 1 and the spiral blade 2b of the orbiting scroll 2 in the scroll compressor 100 of Embodiment 1 have the shapes described below.

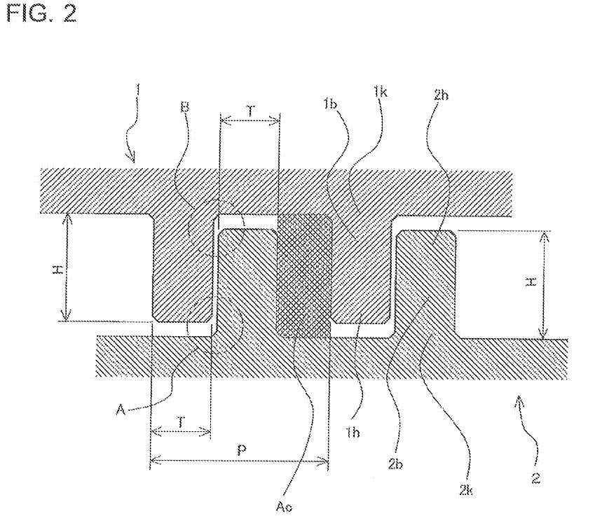

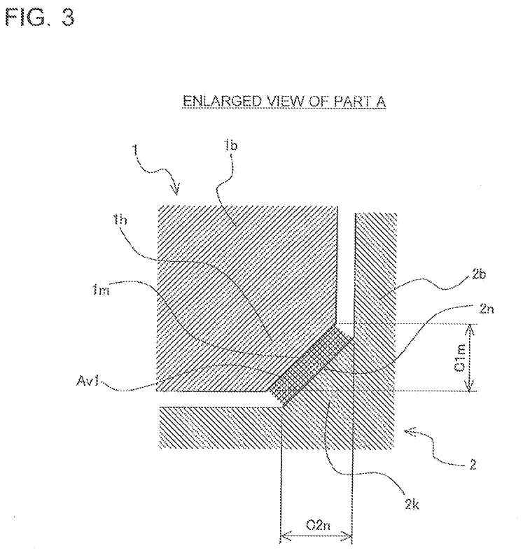

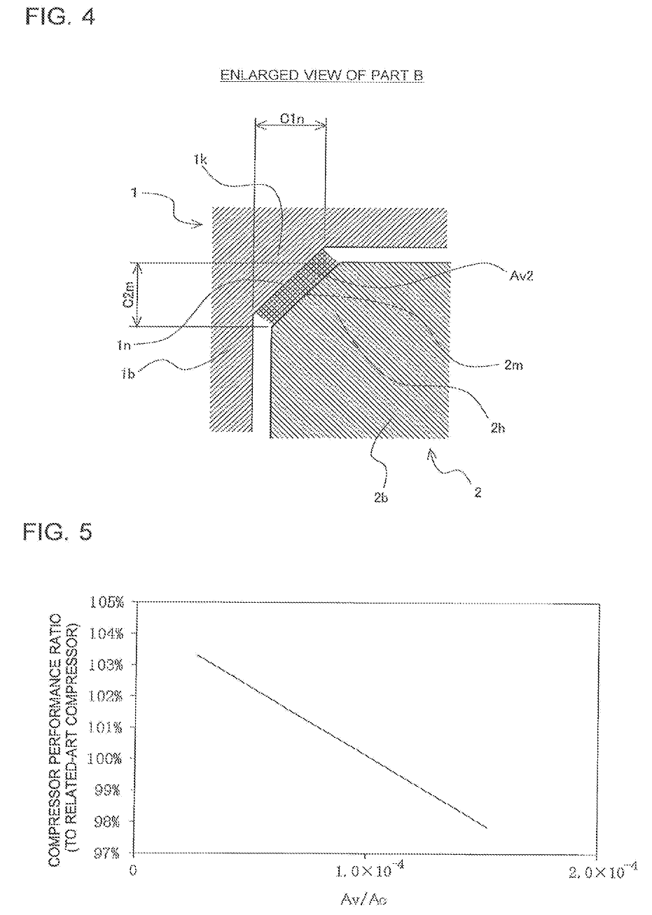

FIG. 2 is a vertical sectional view for illustrating the vicinity of the compression chamber of the scroll compressor of Embodiment 1 of the present invention. FIG. 3 is an enlarged view of the part A of FIG. 2. Further, FIG. 4 is an enlarged view of the part B of FIG. 2. In FIG. 2 to FIG. 4, there is illustrated a cross section that passes through an orbiting center of the orbiting scroll 2, in other words, through an axial center of a main shaft portion 6b of the main shaft 6 and is taken along a standing direction of the spiral blade 1b of the fixed scroll 1 and the spiral blade 2b of the orbiting scroll 2. In the illustrated cross section, the compression chamber 1f has the largest sectional area.

At each of both corner portions of a distal end portion 1h of the spiral blade 1b of the fixed scroll 1, there is formed a chamfered portion 1m having a straight chamfer shape in cross section. On each of both sides (outer peripheral side and inner peripheral side) of a bottom portion 2k (connection portion between the base plate portion 2a and the spiral blade 2b) of the spiral blade 2b of the orbiting scroll 2, there is formed a chamfered portion 2n having the same shape as that of the chamfered portion 1m. That is, the chamfered portion 2n formed at the bottom portion 2k of the spiral blade 2b of the orbiting scroll 2 is shaped to be along the chamfered portion 1m when the chamfered portion 1m formed at the distal end portion 1h of the spiral blade 1b of the fixed scroll 1 is brought close to the chamfered portion 2n.

Further, at each of both corner portions of a distal end portion 2h of the spiral blade 2b of the orbiting scroll 2, there is formed a chamfered portion 2m having a straight chamfer shape in cross section. On each of both sides (outer peripheral side and inner peripheral side) of a bottom portion 1k (connection portion between the base plate portion 1a and the spiral blade 1b) of the spiral blade 1b of the fixed scroll 1, there is formed a chamfered portion 1n having the same shape as that of the chamfered portion 2m. That is, the chamfered portion 1n formed at the bottom portion 1k of the spiral blade 1b of the fixed scroll 1 is shaped to be along the chamfered portion 2m when the chamfered portion 2m formed at the distal end portion 2h of the spiral blade 2b of the orbiting scroll 2 is brought close to the chamfered portion 1n.

Herein, the chamfered portion 1m corresponds to a first chamfered portion of the present invention. The chamfered portion 2m corresponds to a second chamfered portion of the present invention. The chamfered portion 1n corresponds to a third chamfered portion of the present invention. Further, the chamfered portion 2n corresponds to a fourth chamfered portion of the present invention. In Embodiment 1, the chamfered portion 1m and the chamfered portion 2m are formed to have an equal size (chamfer dimension), and the chamfered portion 1n and the chamfered portion 2n are formed to have an equal size (chamfer dimension).

Further, in the scroll compressor 100 of Embodiment 1, a space formed between the chamfered portion 1m and the chamfered portion 2n and a space formed between the chamfered portion 2m and the chamfered portion 1n are set as described below.

In detail, as illustrated in FIG. 3, a sectional area of the space formed between the chamfered portion 1m and the chamfered portion 2n under a state in which the chamfered portion 1m and the chamfered portion 2n are arranged closest to each other is defined as Av1. That is, an area surrounded by the chamfered portion 1m, the chamfered portion 2n, and imaginary straight lines connecting ends of the chamfered portion 1m and ends of the chamfered portion 2n is defined as Av1. Further, as illustrated in FIG. 4, a sectional area of the space formed between the chamfered portion 2m and the chamfered portion 1n under a state in which the chamfered portion 2m and the chamfered portion 1n are arranged closest to each other is defined as Av2. That is, an area surrounded by the chamfered portion 2m, the chamfered portion 1n, and imaginary straight lines connecting ends of the chamfered portion 2m and ends of the chamfered portion 1n is defined as Av2. Further, as illustrated in FIG. 2, a sectional area of the compression chamber 1f, that is, the largest sectional area of the compression chamber 1f in the cross section that passes through the orbiting center of the orbiting scroll 2 and is taken along the standing direction of the spiral blade 1b of the fixed scroll 1 and the spiral blade 2b of the orbiting scroll 2 is defined as Ac. When Av1, Av2, and Ac are defined as described above, the scroll compressor 100 of Embodiment 1 is set by the following expression.

0<{(Av1+Av2)/2}/Ac<1×10⁻⁴

As described above, in Embodiment 1, the chamfered portion 1m and the chamfered portion 2m are formed to have an equal size (chamfer dimension), and the chamfered portion 1n and the chamfered portion 2n are formed to have an equal size (chamfer dimension). That is, in Embodiment 1, an expression of Av1=Av2=Av is satisfied. Consequently, the above-mentioned expression can also be expressed with the following expression.

0<Av/Ac<1×10⁻⁴

The sectional area Ac of the compression chamber 1f can be calculated with a height H, a pitch P, and a thickness T of the spiral blade 1b of the fixed scroll 1 and the spiral blade 2b of the orbiting scroll 2 by the following expression.

Ac=(P−2×T)×H

Referring back to FIG. 1, the compliant frame 3 is stored in the guide frame 4. At an outer peripheral portion of the compliant frame 3, there are provided an upper cylindrical surface 3p and a lower cylindrical surface 3s. At an inner peripheral portion of the guide frame 4, there are provided an upper cylindrical surface 4c and a lower cylindrical surface 4d into which the upper cylindrical surface 3p and the lower cylindrical surface 3s of the compliant frame 3 are inserted, respectively. By the insertion of the upper cylindrical surface 3p and the lower cylindrical surface 3s into the upper cylindrical surface 4c and the lower cylindrical surface 4d, respectively, the compliant frame 3 is radially supported in the guide frame 4. Further, at a center portion of the lower cylindrical surface 3s of the compliant frame 3, there are provided a main bearing 3c and an auxiliary main bearing 3d that are configured to radially support the main shaft portion 6b of the main shaft 6 driven to rotate by a rotor 5a of the electric motor 5. Further, in the compliant frame 3, there is formed a communication hole 3e that penetrates from a surface of the thrust bearing 3a to the outer peripheral portion of the compliant frame 3 in an axial direction. A thrust bearing opening portion 3t that is opened at an upper end of the communication hole 3e is arranged to face the gas extraction hole 2e penetrating through the base plate portion 2a of the orbiting scroll 2.

Further, on an outer peripheral side of the thrust bearing 3a of the compliant frame 3, there is formed a surface 3b (reciprocation slide surface) on which an Oldham mechanism annular portion 9c is reciprocally slidable, and a communication hole 3f that allows communication between a base plate outer peripheral space 20 and a frame upper space 4a is formed to communicate with an inner side of the Oldham mechanism annular portion 9c. Further, in the compliant frame 3, there is formed a communication hole 3m between the frame upper space 4a and a boss portion outer space 2g. In the communication hole 3m, there is formed an intermediate pressure adjustment valve storage space 3n for storing an intermediate pressure adjustment valve 3g configured to adjust a pressure in the boss portion outer space 2g, an intermediate pressure adjustment valve pressing member 3h, and an intermediate pressure adjustment spring 3k. The intermediate pressure adjustment spring 3k is stored under a state in which the intermediate pressure adjustment spring 3k is compressed from its natural length.

In Embodiment 1, the compliant frame 3 and the guide frame 4 are constructed separately from each other. However, the frames are not limited to this configuration, and both frames may be integrally constructed to form a single frame.

A frame lower space 4b formed between an inner surface of the guide frame 4 and an outer surface of the compliant frame 3 is partitioned by ring-shaped sealing members 7a and 7b on upper and lower sides of the frame lower space 4b. Herein, ring-shaped sealing grooves configured to store the ring-shaped sealing members 7a and 7b are formed at two locations in an outer peripheral surface of the compliant frame 3. However, the sealing grooves may be formed in an inner peripheral surface of the guide frame 4. The frame lower space 4b communicates only with the communication hole 3e of the compliant frame 3, and the refrigerant gas that is being compressed and is fed through the gas extraction hole 2e is sealed in the frame lower space 4b. Further, a space on an outer peripheral side of the thrust bearing 3a that is surrounded by the base plate portion 2a of the orbiting scroll 2 and the compliant frame 3 on upper and lower sides, that is, the base plate outer peripheral space 20 is a low-pressure space of a suction gas atmosphere (suction pressure).

An outer peripheral surface of the guide frame 4 is fixed to the hermetic container 10, for example, by shrinkage fitting or by welding. On the guide frame 4 and the fixed scroll 1, that is, on an outer peripheral portion of the compression mechanism 14, there is provided a first passage 4f formed by cutting. The refrigerant gas discharged through the discharge port 1d to the high-pressure space 10a of the hermetic container 10 passes through the first passage 4f to flow to a lower side of the hermetic container 10. A bottom portion of the hermetic container 10 serves as a reservoir for storing a refrigerating machine oil 11.

In the hermetic container 10, there is provided the discharge pipe 12 configured to discharge the refrigerant gas to an outside. The above-mentioned first passage 4f is provided at a position on a side opposite to the discharge pipe 12. Further, there is provided a first discharge passage 4g that communicates from a center at a lower end of the guide frame 4 to a side surface of the guide frame 4, and the first discharge passage 4g communicates with the discharge pipe 12.

The electric motor 5 is configured to drive the main shaft 6 to rotate, and is constructed of, for example, the rotor 5a fixed to the main shaft portion 6b of the main shaft 6 and a stator 5b fixed to the hermetic container 10. The rotor 5a is fixed to the main shaft portion 6b of the main shaft 6 by shrinkage fitting. The rotor 5a is driven to rotate by the start of energization to the stator 5b, to thereby rotate the main shaft 6. Further, at an upper end of the main shaft 6, there is formed the orbiting shaft portion 6a that is rotatably engaged with the orbiting bearing 2d of the orbiting scroll 2. A main shaft balance weight 6f is fixed to the main shaft 6 on a lower side of the orbiting shaft portion 6a by shrinkage fitting.

Further, on the lower side of the orbiting shaft portion 6a, there is formed the main shaft portion 6b that is rotatably engaged with the main bearing 3c and the auxiliary main bearing 3d of the compliant frame 3. Further, at a lower end of the main shaft 6, there is formed a sub shaft portion 6c that is rotatably engaged with a sub bearing 8a of a sub frame 8. In the main shaft 6, there is formed a high-pressure oil feeding hole 6e that is formed of a hole penetrating through the main shaft 6 in the axial direction. Thus, the refrigerating machine oil 11 is sucked through an oil feeding port 6d of the high-pressure oil feeding hole 6e by an oil feeding mechanism or a pump mechanism arranged at a lower portion of the main shaft 6. An upper end of the high-pressure oil feeding hole 6e is opened to the orbiting bearing 2d of the orbiting scroll 2, and the sucked refrigerating machine oil 11 flows out through an upper end opening of the high-pressure oil feeding hole 6e to the orbiting bearing 2d so that the orbiting shaft portion 6a and the orbiting bearing 2d are lubricated. Further, an oil feeding hole 6g that branches off in a horizontal direction is formed in the high-pressure oil feeding hole 6e. The refrigerating machine oil 11 is fed through the oil feeding hole 6g to the auxiliary main bearing 3d, to thereby lubricate the main bearing 3c, the auxiliary main bearing 3d, and the main shaft portion 6b.

A first balance weight 15a is fixed to an upper end surface of the rotor 5a, and a second balance weight 15b is fixed to a lower end surface of the rotor 5a. The first balance weight 15a and the second balance weight 15b are located at eccentric positions that are diagonally arranged to each other. Further, in a space outside the orbiting bearing 2d, the above-mentioned main shaft balance weight 6f is fixed to the main shaft 6 on the lower side of the orbiting shaft portion 6a. The three balance weights 15a, 15b, and 6f cancel out imbalance in centrifugal forces and moment forces that are generated by the orbiting motion of the orbiting scroll 2 through intermediation of the orbiting shaft portion 6a of the main shaft 6, thereby achieving static balance and dynamic balance.

In the rotor 5a, there are provided a plurality of penetrating flow passages 5f each penetrating in the axial direction. Further, the penetrating flow passages 5f are provided to avoid installation positions of the first balance weight 15a and the second balance weight 15b. The penetrating flow passages 5f may be formed to penetrate through the first balance weight 15a and the second balance weight 15b.

An outer peripheral surface of the stator 5b of the electric motor 5 is fixed to the hermetic container 10 by, for example, shrinkage fitting or welding. In the outer peripheral portion of the stator 5b, there is provided a second passage 5g formed by cutting. The first passage 4f and the second passage 5g described above construct a refrigerant flow passage for guiding the refrigerant gas discharged through the discharge port 1d to the bottom portion of the hermetic container 10.

Further, as illustrated in FIG. 1, glass terminals 10b are disposed on a side surface of the hermetic container 10. The glass terminals 10b and the stator 5b of the electric motor 5 are connected to each other by lead lines 5h.

Next, an operation of the scroll compressor 100 of Embodiment 1 is described.

At the time of activation and operation of the scroll compressor 100, the refrigerant gas is sucked through the suction pipe 13 and the suction port 1e to enter the space formed between the spiral blade 1b of the fixed scroll 1 and the spiral blade 2b of the orbiting scroll 2. When the orbiting scroll 2 driven by the electric motor 5 performs an eccentric turning motion (orbiting motion), the space formed between the spiral blade 1b of the fixed scroll 1 and the spiral blade 2b of the orbiting scroll 2 is prevented from communicating with the suction port 1e and forms the compression chamber 1f. The compression chamber 1f is reduced in volume as the orbiting scroll 2 performs the eccentric turning motion. The compression stroke causes the refrigerant gas in the compression chamber 1f to have a high pressure. In the above-mentioned compression stroke, the refrigerant gas that is being compressed and having an intermediate pressure is guided to the frame lower space 4b from the gas extraction hole 2e of the orbiting scroll 2 through the communication hole 3e of the compliant frame 3, thereby maintaining the intermediate pressure atmosphere in the frame lower space 4b.

When the compression chamber 1f communicates with the discharge port 1d of the fixed scroll 1, the refrigerant gas caused to have a high pressure through the above-mentioned compression stroke is discharged through the discharge port 1d to the high-pressure space 10a of the hermetic container 10. At this time, the refrigerant gas is mixed with the refrigerating machine oil 11 having lubricated the sliding surface of the compression mechanism 14, and then is discharged as mixture gas from the discharge port 1d. The mixture gas passes through the first passage 4f provided in the outer peripheral portion of the compression mechanism 14 and the second passage 5g provided in the outer peripheral portion of the stator 5b of the electric motor 5, and is guided to the space below the electric motor 5, that is, to the bottom portion of the hermetic container 10. The mixture gas is separated in the course of being guided to the bottom portion of the hermetic container 10. The refrigerant gas separated from the refrigerating machine oil 11 flows into the penetrating flow passage 5f provided in the rotor 5a, passes through the first discharge passage 4g, and further passes through the discharge pipe 12 to be discharged to an outside of the hermetic container 10.

As the scroll compressor 100 operates, that is, as the main shaft 6 rotates, the refrigerating machine oil 11 in the bottom portion of the hermetic container 10 flows through the oil feeding port 6d into the high-pressure oil feeding hole 6e, and then flows upward in the high-pressure oil feeding hole 6e. A part of the refrigerating machine oil 11 that flows through the high-pressure oil feeding hole 6e is guided from an opening at an upper end to a space formed between an upper surface of the orbiting shaft portion 6a and the orbiting bearing 2d. Then, the refrigerating machine oil 11 is reduced in pressure in the gap that is narrowest in this oil feeding passage, between the orbiting shaft portion 6a and the orbiting bearing 2d, to have an intermediate pressure higher than a suction pressure and equal to or less than a discharge pressure, and flows to the boss portion outer space 2g. Meanwhile, another part of the refrigerating machine oil 11 that flows through the high-pressure oil feeding hole 6e is guided from the oil feeding hole 6g to a high-pressure-side end surface (lower end surface in FIG. 1) of the main bearing 3c. Then, the refrigerating machine oil 11 is reduced in pressure in a space that is narrowest in this oil feeding passage, between the main bearing 3c and the main shaft portion 6b, to have an intermediate pressure, and similarly flows to the boss portion outer space 2g. When the refrigerating machine oil 11 having the intermediate pressure in the boss portion outer space 2g (foaming of refrigerant dissolved in the refrigerating machine oil 11 generally causes the refrigerating machine oil 11 to form a two-phase flow of refrigerant gas and refrigerating machine oil) passes through the communication hole 3m and the intermediate pressure adjustment valve storage space 3n, the refrigerating machine oil 11 overcomes a force exerted by an intermediate pressure adjustment spring 3k, pushes up the intermediate pressure adjustment valve 3g, and flows to the frame upper space 4a. Subsequently, the refrigerating machine oil 11 is discharged through the communication hole 3f into the Oldham mechanism annular portion 9c.

Also after the refrigerating machine oil 11 is fed to a sliding portion between the thrust surface 2f of the orbiting scroll 2 and a sliding portion of the thrust bearing 3a of the compliant frame 3, the refrigerating machine oil 11 is discharged into the Oldham mechanism annular portion 9c. Then, the refrigerating machine oil 11 discharged through the above-mentioned configuration is fed to a sliding surface and a key sliding surface of the Oldham mechanism annular portion 9c, and then is released to the base plate outer peripheral space 20.

As described above, an intermediate pressure Pm1 in the boss portion outer space 2g is controlled by a predetermined pressure α that is approximately determined on the basis of a spring force of the intermediate pressure adjustment spring 3k and an intermediate pressure exposure area of the intermediate pressure adjustment valve 3g, in accordance with the following expression.

Pm1=Ps+α

(Ps is a suction atmosphere pressure, that is, a low pressure)

Further, in FIG. 1, a lower opening portion of the gas extraction hole 2e formed in the base plate portion 2a of the orbiting scroll 2 regularly or intermittently communicates with the thrust bearing opening portion 3t, that is, an upper opening portion (opening portion on an upper side in FIG. 1) of the communication hole 3e formed in the compliant frame 3. Thus, the refrigerant gas that is being compressed and discharged from the compression chamber 1f formed between the fixed scroll 1 and the orbiting scroll 2, that is, the refrigerant gas having the intermediate pressure higher than the suction pressure and equal to or less than the discharge pressure is guided to the frame lower space 4b through the gas extraction hole 2e of the orbiting scroll 2 and the communication hole 3e of the compliant frame 3. However, even though the refrigerant gas is guided, the frame lower space 4b is a closed space that is sealed by the ring-shaped sealing member 7a and the ring-shaped sealing member 7b, and hence, during a normal operation, the refrigerant gas has a slight flow in both directions between the compression chamber 1f and the frame lower space 4b in response to the pressure fluctuation in the compression chamber 1f, that is, a state of breathing is provided. As described above, an intermediate pressure Pm2 of the frame lower space 4b is controlled by a predetermined magnification β approximately determined by a position of the compression chamber 1f communicated with the frame lower space 4b, in accordance with the following expression.

Pm2=Ps×β

(Ps is a suction atmosphere pressure, that is, a low pressure)

With the above-mentioned configuration, that is, with the two intermediate pressures Pm1 and Pm2 and the pressure in the high-pressure space 10a applied to the lower end surface 3v of the compliant frame 3, the compliant frame 3 is guided by the guide frame 4 to move toward the fixed scroll 1 side (upper side in FIG. 1). Thus, the orbiting scroll 2 being pressed by the compliant frame 3 through the thrust bearing 3a also moves upward. As a result, the distal end portion 2h of the spiral blade 2b of the orbiting scroll 2 slides in contact with the base plate portion 1a of the fixed scroll 1, and the distal end portion 1h of the spiral blade 1b of the fixed scroll 1 slides in contact with the base plate portion 2a of the orbiting scroll 2, to thereby compress the refrigerant gas.

Herein, the related-art scroll compressor has a problem in that, during the above-mentioned compression stroke, a gap formed between the distal end portion of the spiral blade and the bottom portion of the spiral blade is increased to cause an increase in amount of leakage of the refrigerant gas that is being compressed, increasing leakage loss. However, in the scroll compressor 100 of Embodiment 1, the chamfered portion 1m is formed at the distal end portion 1h of the spiral blade 1b of the fixed scroll 1, and the chamfered portion 2n having the same shape as that of the chamfered portion 1m is formed at the bottom portion 2k of the spiral blade 2b of the orbiting scroll 2. Further, the chamfered portion 2m is formed at the distal end portion 2h of the spiral blade 2b of the orbiting scroll 2, and the chamfered portion 1n having the same shape as that of the chamfered portion 2m is formed at the bottom portion 1k of the spiral blade 1b of the fixed scroll 1. Further, the configuration satisfying the expression of 0<Av/Ac<1×10⁻⁴ is achieved. Consequently, the scroll compressor 100 of Embodiment 1 is capable of preventing the leakage of the refrigerant gas that is being compressed from the gap between the distal end portion of the spiral blade and the bottom portion of the spiral blade, thereby being capable of preventing an increase in leakage loss. Thus, the scroll compressor 100 of Embodiment 1 is capable of achieving a highly efficient scroll compressor.

FIG. 5 is a graph for showing a relationship between Av/Ac and a compressor performance in the scroll compressor of Embodiment 1 of the present invention. In FIG. 5, the performance of the scroll compressor 100 of Embodiment 1 is indicated by a compressor performance ratio. The compressor performance ratio indicates a ratio of the performance of the scroll compressor 100 of Embodiment 1 to the performance of the related-art scroll compressor. The compressor performance ratio exceeding 100% indicates that the performance of the scroll compressor 100 of Embodiment 1 exceeds the performance of the related-art scroll compressor.

Further, the term “performance” as used herein corresponds to a coefficient of performance (COP). The coefficient of performance (COP) can be calculated with the following expression.

COP=Refrigeration capacity/Consumed power

That is, under a state in which the scroll compressor 100 is mounted as a compressor for a refrigeration cycle circuit, and the refrigeration cycle circuit is operated with a predetermined refrigeration capacity, the performance of the scroll compressor 100 of Embodiment 1 is calculated by dividing the refrigeration capacity by consumed power of the scroll compressor 100. Under a state in which the related-art scroll compressor is mounted to the refrigeration cycle circuit used for the calculation of the performance of the scroll compressor 100 of Embodiment 1, and the refrigeration cycle circuit is operated with the predetermined refrigeration capacity, the performance of the related-art scroll compressor is calculated by dividing the refrigeration capacity by the consumed power of the scroll compressor.

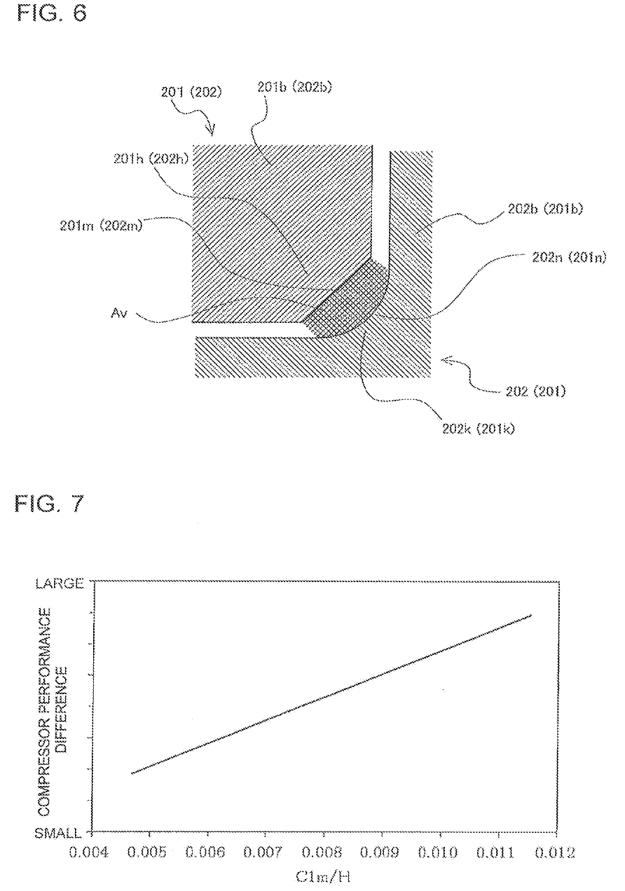

In the related-art scroll compressor used for the calculation of the compressor performance ratio in FIG. 5, spiral blades of a fixed scroll and an orbiting scroll are formed as illustrated in FIG. 6. That is, at each of both corner portions of a distal end portion 201h of a spiral blade 201b of a fixed scroll 201, there is formed a chamfered portion 201m having a straight chamfer shape in cross section. On each of both sides of a bottom portion 202k of a spiral blade 202b of an orbiting scroll 202, there is formed a chamfered portion 202n having an arcuate chamfer shape in cross section. Similarly, at each of both corner portions of a distal end portion 202h of the spiral blade 202b of the orbiting scroll 202, there is formed a chamfered portion 202m having a straight chamfer shape in cross section. On each of both sides of a bottom portion 201k of the spiral blade 201b of the fixed scroll 201, there is formed a chamfered portion 201n having an arcuate chamfer shape in cross section. The related-art scroll compressor satisfies an expression of Av/Ac=1×10⁻⁴.

As illustrated in FIG. 6, in the related-art scroll compressor, the chamfer shape of the distal end portion of the spiral blade is straight in cross section, and the chamfer shape of the bottom portion of the spiral blade is arcuate in cross section. Thus, in the related-art scroll compressor, a sectional area Av of a space formed between the distal end portion and the bottom portion of the spiral blades cannot be reduced, and hence there is difficulty in setting Av/Ac to be less than 1×10⁻⁴. Meanwhile, in the scroll compressor 100 of Embodiment 1, the chamfered portion 1m is formed at the distal end portion 1h of the spiral blade 1b of the fixed scroll 1, and the chamfered portions 2n having the same shape as that of the chamfered portion 1m is formed at the bottom portion 2k of the spiral blade 2b of the orbiting scroll 2. Further, the chamfered portion 2m is formed at the distal end portion 2h of the spiral blade 2b of the orbiting scroll 2, and the chamfered portion 1n having the same shape as that of the chamfered portion 2m is formed at the bottom portion 1k of the spiral blade 1b of the fixed scroll 1. Thus, in the scroll compressor 100 of Embodiment 1, a sectional area Av of a space formed between the distal end portion and the bottom portion of the spiral blades can be set less than that of the related-art scroll compressor. Thus, the configuration satisfying the expression of Av/Ac<1×10⁻⁴ can be achieved. Thus, as illustrated in FIG. 5, the scroll compressor 100 of Embodiment 1 is capable of preventing leakage of the refrigerant gas that is being compressed from the gap between the distal end portion of the spiral blade and the bottom portion of the spiral blade, thereby being capable of preventing the increase in leakage loss. That is, the scroll compressor 100 of Embodiment 1 is capable of achieving a highly efficient scroll compressor.

At the end of Embodiment 1, additional remarks are made on that the configuration of the scroll compressor 100 of Embodiment 1 may achieve further improvement in effect of preventing the increase in leakage loss through employment of a scroll compressor including the compression chamber 1f having a small volume.

FIG. 7 is a graph for showing a relationship between C1m/H and a compressor performance in the scroll compressor of Embodiment 1 of the present invention. The C1m corresponds to a chamfer dimension C1m (see FIG. 3) of the chamfered portion 1m formed at the distal end portion 1h of the spiral blade 1b of the fixed scroll 1. In Embodiment 1, the chamfered portion 1m and the chamfered portion 2m have an equal size (chamfer dimension), and hence an expression of C1m=C2m is satisfied. The C2m corresponds to a chamfer dimension C2m (see FIG. 4) of the chamfered portion 2m formed at the distal end portion 1h of the spiral blade 2b of the orbiting scroll 2.

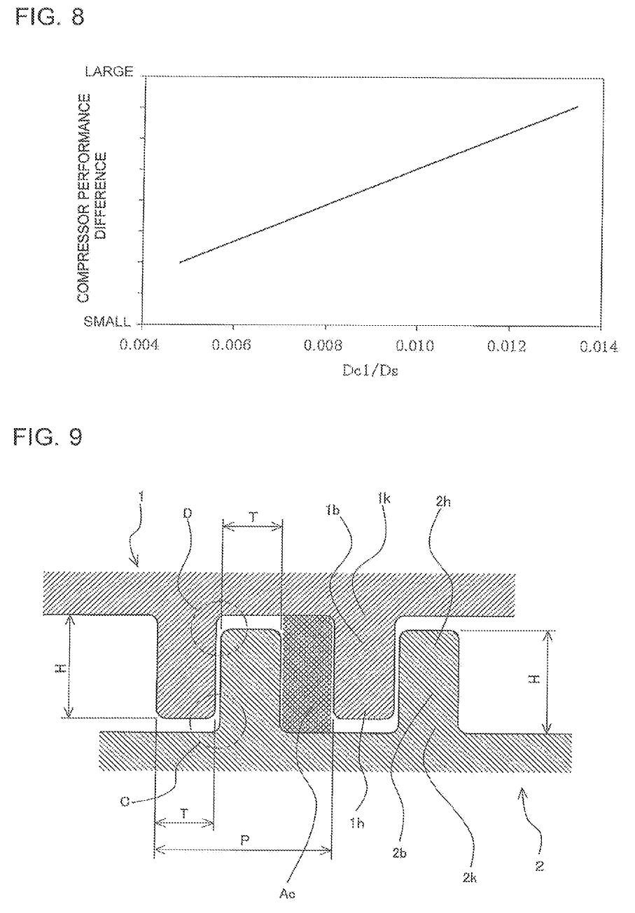

FIG. 8 is a graph for showing a relationship between Dc1/Ds and a compressor performance in the scroll compressor of Embodiment 1 of the present invention. The Dc1 represents an equivalent hydraulic diameter of the sectional area Av1 of the space formed between the chamfered portion 1m and the chamfered portion 2n. Further, the Ds represents an equivalent hydraulic diameter of the sectional area Ac of the compression chamber 1f. As described above, in Embodiment 1, the chamfered portion 1m and the chamfered portion 2m are formed to have an equal size (chamfer dimension), and the chamfered portion 1n and the chamfered portion 2n are formed to have an equal size (chamfer dimension). Thus, the equivalent hydraulic diameter Dc2 of the sectional area Av2 of the space formed between the chamfered portion 2m and the chamfered portion 1n satisfies an expression of Dc2=Dc1.

The equivalent hydraulic diameter D can be calculated with the following expression.

D=4×(Flow passage sectional area)/(Peripheral length of flow passage cross section)

Thus, the equivalent hydraulic diameter Ds of the sectional area Ac of the compression chamber 1f can be calculated with the following expression.

Ds=4×Ac/{2×(P−2×T)+2×H)

Further, the equivalent hydraulic diameter Dc1 of the sectional area Av1 of the space formed between the chamfered portion 1m and the chamfered portion 2n can be calculated with the following expression.

Dc1=4×Av1/(a sum of lengths of the chamfered portion 1m, the chamfered portion 2n, and the imaginary straight lines connecting the ends of the chamfered portion 1m to the ends of the chamfered portion 2n)

In FIG. 7 and FIG. 8, the performance of the scroll compressor 100 of Embodiment 1 is shown as a compressor performance difference. The compressor performance difference is calculated by subtracting the performance of the related-art scroll compressor from the performance of the scroll compressor 100 of Embodiment 1.

In FIG. 7, under a state in which the chamfer dimension C1m of the chamfered portion 1m formed in the distal end portion 1h of the spiral blade 1b of the fixed scroll 1 is fixed, as a height H of the spiral blade 1b of the fixed scroll 1 is reduced, a value of C1m/H increases. That is, in FIG. 7, the volume of the compression chamber 1f is smaller on the right side. Further, in FIG. 8, under a state in which the equivalent hydraulic diameter Dc1 of the sectional area Av1 of the space formed between the chamfered portion 1m and the chamfered portion 2n is fixed, as the equivalent hydraulic diameter Ds of the sectional area Ac of the compression chamber 1f is reduced, a value of Dc1/Ds increases. That is, also in FIG. 8, the volume of the compression chamber 1f is smaller on the right side, as in FIG. 7.

When the sectional area Av of the space formed between the distal end portion and the bottom portion of the spiral blades is the same, the amount of refrigerant gas that leaks from the gap between the distal end portion and the bottom portion of the spiral blades in the scroll compressor having a small volume of the compression chamber is substantially equal to that of the scroll compressor having a large volume of the compression chamber. That is, when the sectional area Av of the space formed between the distal end portion and the bottom portion of the spiral blades is the same, the amount of leakage of refrigerant gas with respect to the amount of refrigerant gas in the compression chamber in the scroll compressor having the small volume of the compression chamber is larger than that of the scroll compressor having the large volume of the compression chamber. That is, when the sectional area Av of the space formed between the distal end portion and the bottom portion of the spiral blades is the same, leakage loss in the scroll compressor having a small volume of the compression chamber is larger than that of the scroll compressor having a large volume of the compression chamber. Consequently, the efficiency is degraded.

In other words, in the scroll compressor having a small volume of the compression chamber, to achieve the leakage loss equal to that of the scroll compressor having a large volume of the compression chamber, it is necessary to reduce the sectional area Av of the space formed between the distal end portion and the bottom portion of the spiral blades depending on the amount of reduction in volume of the compression chamber. However, as illustrated in FIG. 6, in the related-art scroll compressor, there is difficulty in setting the sectional area Av of the space formed between the distal end portion and the bottom portion of the spiral blades to be less than a certain value. Consequently, in the related-art scroll compressor, when the volume of the compression chamber is smaller than the certain value, the leakage loss increases depending on the amount of reduction in volume of the compression chamber, degrading the efficiency.

Meanwhile, in the scroll compressor 100 of Embodiment 1, as described above, the sectional area Av of the space formed between the distal end portion and the bottom portion of the spiral blades can be set smaller than that of the related-art scroll compressor. Consequently, with the scroll compressor 100 of Embodiment 1, even when the compression chamber has such a volume that the increase in leakage loss cannot be prevented by the related-art scroll compressor, the sectional area Av of the space formed between the distal end portion and the bottom portion of the spiral blades can be reduced depending on the amount of reduction in volume of the compression chamber. That is, with the scroll compressor 100 of Embodiment 1, even when the compression chamber has such a volume that the increase in leakage loss cannot be prevented by the related-art scroll compressor, the increase in leakage loss can be prevented. Consequently, a highly efficient scroll compressor can be achieved. As illustrated in FIG. 7 and FIG. 8, the effect can be improved as the volume of the compression chamber is smaller.

### Embodiment 2

In Embodiment 1, each of the chamfered portion 1m, the chamfered portion 1n, the chamfered portion 2m, and the chamfered portion 2n has a straight chamfer shape in cross section. However, the chamfer shape of the chamfered portion 1m, the chamfered portion 1n, the chamfered portion 2m, and the chamfered portion 2n is not limited to the straight chamfer shape. As long as the chamfered portion 1m and the chamfered portion 2n have the same shape, and the chamfered portion 2m and the chamfered portion 1n have the same shape, the effect described in Embodiment 1 can be achieved. The chamfered portion 1m, the chamfered portion 1n, the chamfered portion 2m, and the chamfered portion 2n may have, for example, a chamfer shape described below. In Embodiment 2, matters that are not particularly described are the same as those of Embodiment 1, and the same function and configuration are described with the same reference signs.

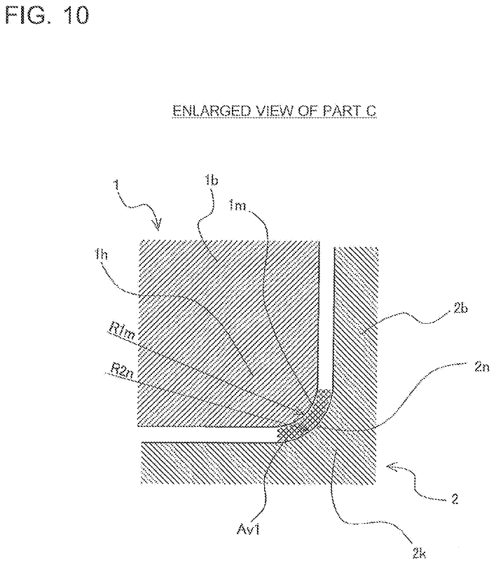

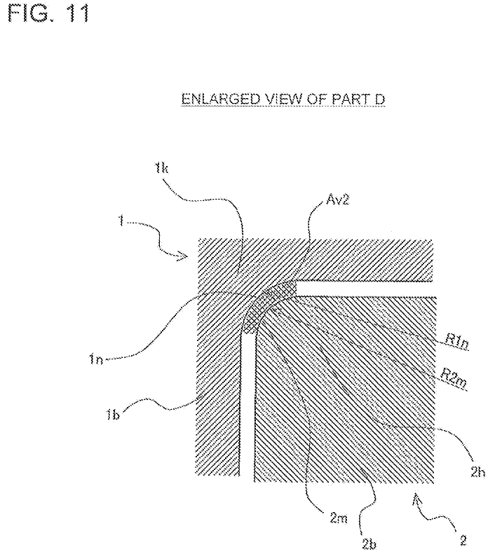

FIG. 9 is a vertical sectional view for illustrating the vicinity of a compression chamber of a scroll compressor of Embodiment 2 of the present invention. FIG. 10 is an enlarged view of the part C of FIG. 9. Further, FIG. 11 is an enlarged view of the part D of FIG. 9. In FIG. 9 to FIG. 11, there is illustrated the cross section that passes through the orbiting center of the orbiting scroll 2, in other words, through the axial center of a main shaft portion 6b of the main shaft 6 and is taken along the standing direction of the spiral blade 1b of the fixed scroll 1 and the spiral blade 2b of the orbiting scroll 2. In the illustrated cross section, the compression chamber 1f has the largest sectional area.

At each of both the corner portions of the distal end portion 1h of the spiral blade 1b of the fixed scroll 1, there is formed the chamfered portion 1m having an arcuate chamfer shape in cross section, specifically, having an arcuate central portion protruding toward the orbiting scroll 2 side. On each of both sides of the bottom portion 2k of the spiral blade 2b of the orbiting scroll 2, there is formed the chamfered portion 2n having the same shape as that of the chamfered portion 1m, specifically, having an arcuate central portion recessing toward an opposite side to the fixed scroll 1. That is, the chamfered portion 2n formed at the bottom portion 2k of the spiral blade 2b of the orbiting scroll 2 is shaped to be along the chamfered portion 1m when the chamfered portion 1m formed at the distal end portion 1h of the spiral blade 1b of the fixed scroll 1 is brought close to the chamfered portion 2n.

Further, at each of both the corner portions of the distal end portion 2h of the spiral blade 2b of the orbiting scroll 2, there is formed the chamfered portion 2m having an arcuate chamfer shape in cross section, specifically, an arcuate central portion protruding toward the fixed scroll 1 side. On each of both the sides of the bottom portion 1k of the spiral blade 1b of the fixed scroll 1, there is formed the chamfered portion 1n having the same shape as that of the chamfered portion 2m, specifically, having an arcuate central portion recessing toward an opposite side toward the orbiting scroll 2 side. That is, the chamfered portion 1n formed at the bottom portion 1k of the spiral blade 1b of the fixed scroll 1 is shaped to be along the chamfered portion 2m when the chamfered portion 2m formed at the distal end portion 2h of the spiral blade 2b of the orbiting scroll 2 is brought close to the chamfered portion 1n.

Further, similarly to Embodiment 1, in the scroll compressor 100 of Embodiment 2, the space formed between the chamfered portion 1m and the chamfered portion 2n and the space formed between the chamfered portion 2m and the chamfered portion 1n are set.

In detail, as illustrated in FIG. 10, the sectional area of the space formed between the chamfered portion 1m and the chamfered portion 2n under the state in which the chamfered portion 1m and the chamfered portion 2n are arranged closest to each other is defined as Av1. That is, the area surrounded by the chamfered portion 1m, the chamfered portion 2n, and the imaginary straight lines connecting ends of the chamfered portion 1m and ends of the chamfered portion 2n is defined as Av1. Further, as illustrated in FIG. 11, the sectional area of the space formed between the chamfered portion 2m and the chamfered portion 1n under the state in which the chamfered portion 2m and the chamfered portion 1n are arranged closest to each other is defined as Av2. That is, the area surrounded by the chamfered portion 2m, the chamfered portion 1n, and the imaginary straight lines connecting ends of the chamfered portion 2m and ends of the chamfered portion 1n is defined as Av2. Further, as illustrated in FIG. 9, the sectional area of the compression chamber 1f, that is, the largest sectional area of the compression chamber 1f in the cross section that passes through the orbiting center of the orbiting scroll 2 and is taken along the standing direction of the spiral blade 1b of the fixed scroll 1 and the spiral blade 2b of the orbiting scroll 2 is defined as Ac. Similarly to Embodiment 1, when Av1, Av2, and Ac are defined as described above, the scroll compressor 100 of Embodiment 2 has a configuration satisfying the following expression.

0<{(Av1+Av2)/2}/Ac<1×10⁻⁴

In Embodiment 2, the chamfered portion 1m and the chamfered portion 2m are formed to have an equal size (chamfer dimension), and the chamfered portion 1n and the chamfered portion 2n are formed to have an equal size (chamfer dimension). That is, in Embodiment 2, the expression of Av1=Av2=Av is satisfied. Consequently, the above-mentioned expression can also be expressed with the following expression.

0<Av/Ac<1×10⁻⁴

As described above, also in the scroll compressor 100 of Embodiment 2, similarly to Embodiment 1, the chamfered portion 1m is formed at the distal end portion 1h of the spiral blade 1b of the fixed scroll 1, and the chamfered portion 2n having the same shape as that of the chamfered portion 1m is formed in the bottom portion 2k of the spiral blade 2b of the orbiting scroll 2. Further, the chamfered portion 2m is formed at the distal end portion 2h of the spiral blade 2b of the orbiting scroll 2, and the chamfered portion 1n having the same shape as that of the chamfered portion 2m is formed in the bottom portion 1k of the spiral blade 1b of the fixed scroll 1. Further, the configuration satisfying the expression of 0<Av/Ac<1×10⁻⁴ is satisfied. Consequently, also with the scroll compressor 100 of Embodiment 2, similarly to Embodiment 1, leakage of the refrigerant gas that is being compressed from the gap between the distal end portion and the bottom portion of the spiral blades can be prevented, thereby preventing the increase in leakage loss. Thus, with the scroll compressor 100 of Embodiment 2, similarly to Embodiment 1, a highly efficient scroll compressor can be achieved.

### Embodiment 3

In Embodiment 1, when the chamfered portion 1m and the chamfered portion 2m each having a straight chamfer shape are formed, the chamfer dimension C1m (see FIG. 3) of the chamfered portion 1m and the chamfer dimension C2m (see FIG. 4) of the chamfered portion 2m are set to be equal to each other. However, the chamfer dimension C1m and the chamfer dimension C2m may be different from one another. As long as the chamfered portion 1m and the chamfered portion 2n have the same shape, and the chamfered portion 2m and the chamfered portion 1n have the same shape, the effect described in Embodiment 1 can be obtained. In Embodiment 3, matters that are not particularly described are the same as those of Embodiment 1, and the same function and configuration are described with the same reference signs.

In the scroll compressor 100 of Embodiment 3, at each of both the corner portions of the distal end portion 1h of the spiral blade 1b of the fixed scroll 1, there is formed the chamfered portion 1m having a straight chamfer shape in cross section. On each of both the sides of the bottom portion 2k of the spiral blade 2b of the orbiting scroll 2, there is formed the chamfered portion 2n having the same shape as that of the chamfered portion 1m. That is, the chamfered portion 2n formed at the bottom portion 2k of the spiral blade 2b of the orbiting scroll 2 is shaped to be along the chamfered portion 1m when the chamfered portion 1m formed at the distal end portion 1h of the spiral blade 1b of the fixed scroll 1 is brought close to the chamfered portion 2n.

Further, at each of both the corner portions of the distal end portion 2h of the spiral blade 2b of the orbiting scroll 2, there is formed the chamfered portion 2m having a straight chamfer shape in cross section. On each of both the sides of the bottom portion 1k of the spiral blade 1b of the fixed scroll 1, there is formed the chamfered portion 1n having the same shape as that of the chamfered portion 2m. That is, the chamfered portion 1n formed at the bottom portion 1k of the spiral blade 1b of the fixed scroll 1 is shaped to be along the chamfered portion 2m when the chamfered portion 2m formed at the distal end portion 2h of the spiral blade 2b of the orbiting scroll 2 is brought close to the chamfered portion 1n.

In the scroll compressor 100 of Embodiment 3, the chamfer dimension C1m (see FIG. 3) of the chamfered portion 1m and the chamfer dimension C2m (see FIG. 4) of the chamfered portion 2m are different from one another. Further, in the scroll compressor 100 of Embodiment 3, the chamfer dimension C2n (see FIG. 3) of the chamfered portion 2n and the chamfer dimension C1n (see FIG. 4) of the chamfered portion 1n are different from one another.

That is, the following relationships are satisfied.

C1m≠C2m

C1n≠C2n

Even when the scroll compressor 100 has such a configuration, the chamfered portion 1m and the chamfered portion 2n can have the same shape, and the chamfered portion 2m and the chamfered portion 1n can have the same shape. Thus, the configuration satisfying the expression of 0<{(Av1+Av2)/2}/Ac<1×10⁻⁴ can be achieved. Consequently, also with the scroll compressor 100 of Embodiment 3, similarly to Embodiment 1, the leakage of the refrigerant gas that is being compressed from the distal end portion and the bottom portion of the spiral blades can be prevented. Consequently, the increase in leakage loss can be prevented. Thus, also with the scroll compressor 100 of Embodiment 3, similarly to Embodiment 1, a highly efficient scroll compressor can be achieved.

Further, with the configuration of the chamfered portion 1m, the chamfered portion 1n, the chamfered portion 2m, and the chamfered portion 2n as in Embodiment 3, the following effect can be obtained.

The spiral blade 1b of the fixed scroll 1 is formed by grinding off, through use of a processing cutter such as an end mill, a periphery of the spiral blade 1b from a material to be formed into the fixed scroll 1. At this time, a chamfer having the same shape as that of the chamfered portion 1n, which is to be formed at the bottom portion 1k of the fixed scroll 1, is formed at a distal end of the processing cutter, that is, a chamfer having the chamfer dimension C1n is formed at a distal end of the processing cutter. Consequently, the chamfered portion 1n can be formed at the bottom portion 1k of the fixed scroll 1. Similarly, the spiral blade 2b of the orbiting scroll 2 is also formed by grinding off, through use of the processing cutter such as an end mill, a periphery of the spiral blade 2b from a material to be formed into the spiral blade 2b. At this time, a chamfer having the same shape as that of the chamfered portion 2n, which is to be formed at the bottom portion 2k of the orbiting scroll 2, is formed at a distal end of the processing cutter, that is, a chamfer having the chamfer dimension C2n is formed at a distal end of the processing cutter. Consequently, the chamfered portion 2n can be formed at the bottom portion 2k of the orbiting scroll 2. The processing cutter for grinding off the spiral blade 1b of the fixed scroll 1 and the spiral blade 2b of the orbiting scroll 2 is abraded earlier at the distal end portion and shorter in life time as the tool as the hardness of the material to be subjected to processing is higher and as the chamfer dimension of the distal end portion is smaller.

Herein, there is a case where a material of the fixed scroll 1 and a material of the orbiting scroll 2 are different from each other. For example, the material of the fixed scroll 1 is cast iron, and the material of the orbiting scroll 2 is aluminum or aluminum alloy. In such a case, it is preferred that a chamfer dimension of one of the chamfered portion 1n and the chamfered portion 2n higher in hardness be set larger and that a chamfer dimension of the other one lower in hardness be set smaller. That is, it is preferred that the chamfer dimension C1n of the chamfered portion 1n formed in the fixed scroll 1 having higher hardness be set larger and that the chamfer dimension C2n of the chamfered portion 2n formed in the orbiting scroll 2 having lower hardness be set smaller. Further, depending on the chamfer dimensions of the chamfered portion 1n and the chamfered portion 2n, the chamfer dimension C1m of the chamfered portion 1m formed in the fixed scroll 1 may be set smaller, and the chamfer dimension C2m of the chamfered portion 2m formed in the orbiting scroll 2 may be set larger.

That is, it is preferred that the following conditions be satisfied.

C1n>C2n

C1m<C2m

With such a configuration, the sectional area Av1 of the gap between the chamfered portion 1m formed in the distal end portion 1h of the spiral blade 1b of the fixed scroll 1 and the chamfered portion 2n formed in the bottom portion 2k of the spiral blade 2b of the orbiting scroll 2 is set smaller than that of Embodiment 1. Further, the sectional area Av2 of the gap formed between the chamfered portion 2m formed in the distal end portion 2h of the spiral blade 2b of the orbiting scroll 2 and the chamfered portion 1n formed in the bottom portion 1k of the spiral blade 1b of the fixed scroll 1 is set larger than that of Embodiment 1.

That is, the following condition is satisfied.

Av1<Av2

With the configuration of the scroll compressor 100 described above, abrasion at the distal end of the processing cutter for grinding off the spiral blade 1b of the fixed scroll 1, that is, abrasion at the distal end of the processing cutter whose distal end portion is abraded early and that is more liable to be short in tool life time can be prevented. Consequently, the tool life time of the processing cutter can be increased. As the tool life time of the processing cutter can be increased, the spiral blade 1b of the fixed scroll 1 can be processed with high accuracy.

### Embodiment 4

In Embodiment 2, when the chamfered portion 1m and the chamfered portion 2m each having an arcuate chamfer shape are formed, a chamfer dimension (arcuate radius) R1m (see FIG. 10) of the chamfered portion 1m and a chamfer dimension (arcuate radius) R2m (see FIG. 11) of the chamfered portion 2m are set to be equal to each other. However, the chamfer dimension R1m and the chamfer dimension R2m may be different from one another. As long as the chamfered portion 1m and the chamfered portion 2n have the same shape, and the chamfered portion 2m and the chamfered portion 1n have the same shape, the effect described in Embodiment 2 can be obtained. In Embodiment 4, matters that are not particularly described are the same as those of Embodiment 2, and the same function and configuration are described with the same reference signs.

In the scroll compressor 100 of Embodiment 4, at each of both the corner portions of the distal end portion 1h of the spiral blade 1b of the fixed scroll 1, there is formed the chamfered portion 1m having an arcuate chamfer shape in cross section. On each of both the sides of the bottom portion 2k of the spiral blade 2b of the orbiting scroll 2, there is formed the chamfered portion 2n having the same shape as that of the chamfered portion 1m. That is, the chamfered portion 2n formed at the bottom portion 2k of the spiral blade 2b of the orbiting scroll 2 is shaped to be along the chamfered portion 1m when the chamfered portion 1m formed at the distal end portion 1h of the spiral blade 1b of the fixed scroll 1 is brought close to the chamfered portion 2n.

Further, at each of both the corner portions of the distal end portion 2h of the spiral blade 2b of the orbiting scroll 2, there is formed the chamfered portion 2m having an arcuate chamfer shape in cross section. On each of both the sides of the bottom portion 1k of the spiral blade 1b of the fixed scroll 1, there is formed the chamfered portion 1n having the same shape as that of the chamfered portion 2m. That is, the chamfered portion 1n formed at the bottom portion 1k of the spiral blade 1b of the fixed scroll 1 is shaped to be along the chamfered portion 2m when the chamfered portion 2m formed at the distal end portion 2h of the spiral blade 2b of the orbiting scroll 2 is brought close to the chamfered portion 1n.

Herein, in the scroll compressor 100 of Embodiment 4, the chamfer dimension R1m (see FIG. 10) of the chamfered portion 1m and the chamfer dimension R2m (see FIG. 11) of the chamfered portion 2m are different from one another. Further, in the scroll compressor 100 of Embodiment 4, a chamfer dimension (arcuate radius) R2n (see FIG. 10) of the chamfered portion 2n and a chamfer dimension (arcuate radius) R1n (see FIG. 11) of the chamfered portion 1n are different from one another. That is, the following relationships are satisfied.

R1m≠R2m

R1n≠R2n

Even when the scroll compressor 100 has such a configuration, the chamfered portion 1m and the chamfered portion 2n can have the same shape, and the chamfered portion 2m and the chamfered portion 1n can have the same shape. Thus, the configuration satisfying the expression of 0<{(Av1+Av2)/2}/Ac<1×10⁻⁴ can be achieved. Consequently, also with the scroll compressor 100 of Embodiment 4, similarly to Embodiment 2, the leakage of the refrigerant gas that is being compressed from the distal end portion and the bottom portion of the spiral blades can be prevented. Consequently, the increase in leakage loss can be prevented. Thus, also with the scroll compressor 100 of Embodiment 4, similarly to Embodiment 2, a highly efficient scroll compressor can be achieved.

Further, with the configuration of the chamfered portion 1m, the chamfered portion 1n, the chamfered portion 2m, and the chamfered portion 2n as in Embodiment 4, the following effect can be obtained.

The spiral blade 1b of the fixed scroll 1 is formed by grinding off, through use of the processing cutter such as an end mill, the periphery of the spiral blade 1b from the material to be formed into the fixed scroll 1. At this time, the chamfer having the same shape as that of the chamfered portion 1n, which is to be formed at the bottom portion 1k of the fixed scroll 1, is formed at the distal end of the processing cutter, that is, the chamfer having the chamfer dimension R1n is formed at the distal end of the processing cutter. Consequently, the chamfered portion 1n can be formed at the bottom portion 1k of the fixed scroll 1. Similarly, the spiral blade 2b of the orbiting scroll 2 is also formed by grinding off, through use of the processing cutter such as an end mill, the periphery of the spiral blade 2b from the material to be formed into the spiral blade 2b. At this time, the chamfer having the same shape as that of the chamfered portion 2n, which is to be formed at the bottom portion 2k of the orbiting scroll 2, is formed at the distal end of the processing cutter, that is, the chamfer having the chamfer dimension R2n is formed at the distal end of the processing cutter. Consequently, the chamfered portion 2n can be formed at the bottom portion 2k of the orbiting scroll 2. The processing cutter for grinding off the spiral blade 1b of the fixed scroll 1 and the spiral blade 2b of the orbiting scroll 2 is abraded earlier at the distal end portion and shorter in life time as the tool as the hardness of the material to be subjected to processing is higher and as the chamfer dimension of the distal end portion is smaller.

Herein, there is the case where the material of the fixed scroll 1 and the material of the orbiting scroll 2 are different from each other. For example, the material of the fixed scroll 1 is cast iron, and the material of the orbiting scroll 2 is aluminum or aluminum alloy. In such a case, it is preferred that a chamfer dimension of one of the chamfered portion 1n and the chamfered portion 2n higher in hardness be set larger and that a chamfer dimension of the other one lower in hardness be set smaller. That is, it is preferred that the chamfer dimension R1n of the chamfered portion 1n formed in the fixed scroll 1 having higher hardness be set larger and that the chamfer dimension R2n of the chamfered portion 2n formed in the orbiting scroll 2 having lower hardness be set smaller. Further, depending on the chamfer dimensions of the chamfered portion 1n and the chamfered portion 2n, the chamfer dimension R1m of the chamfered portion 1m formed in the fixed scroll 1 may be set smaller, and the chamfer dimension R2m of the chamfered portion 2m formed in the orbiting scroll 2 may be set larger.

That is, it is preferred that the following conditions be satisfied.

R1n>R2n

R1m<R2m

With such a configuration, the sectional area Av1 of the gap between the chamfered portion 1m formed in the distal end portion 1h of the spiral blade 1b of the fixed scroll 1 and the chamfered portion 2n formed in the bottom portion 2k of the spiral blade 2b of the orbiting scroll 2 is set smaller than that of Embodiment 2. Further, the sectional area Av2 of the gap formed between the chamfered portion 2m formed in the distal end portion 2h of the spiral blade 2b of the orbiting scroll 2 and the chamfered portion 1n formed in the bottom portion 1k of the spiral blade 1b of the fixed scroll 1 is set larger than that of Embodiment 2.

That is, the following condition is satisfied.

Av1<Av2

With the configuration of the scroll compressor 100 described above, the abrasion at the distal end of the processing cutter for grinding off the spiral blade 1b of the fixed scroll 1, that is, the abrasion at the distal end of the processing cutter whose distal end portion is abraded early and that is more liable to be short in tool life time can be prevented. Consequently, the tool life time of the processing cutter can be increased. As the tool life time of the processing cutter can be increased, the spiral blade 1b of the fixed scroll 1 can processed with high accuracy.

### REFERENCE SIGNS LIST

1 fixed scroll 1a base plate portion 1b spiral blade 1c Oldham guide groove 1d discharge port 1e suction port 1f compression chamber
1h distal end portion 1k bottom portion 1m chamfered portion 1n chamfered portion 2 orbiting scroll 2a base plate portion 2b spiral blade 2c Oldham guide groove 2d orbiting bearing 2e gas extraction hole 2f thrust surface 2g boss portion outer space 2h distal end portion 2k bottom portion 2m chamfered portion 2n chamfered portion 2o base plate outer peripheral space 3 compliant frame 3a thrust bearing 3b surface 3c main bearing 3d auxiliary main bearing 3e communication hole 3f communication hole 3g intermediate pressure adjustment valve 3h intermediate pressure adjustment valve pressing member 3k intermediate pressure adjustment spring 3m communication hole 3n intermediate pressure adjustment valve storage space 3p upper cylindrical surface 3s lower cylindrical surface 3t thrust bearing opening portion 3v lower end surface 4 guide frame 4a frame upper space 4b frame lower space 4c upper cylindrical surface 4d lower cylindrical surface 4f first passage 4g first discharge passage 5 electric motor 5a rotor 5b stator 5f penetrating flow passage 5g second passage 5h lead line 6 main shaft 6a orbiting shaft portion 6b main shaft portion 6c sub shaft portion 6d oil feeding port 6e high-pressure oil feeding hole 6f main shaft balance weight 6g oil feeding hole 7a ring-shaped sealing member 7b ring-shaped sealing member 8 sub frame 8a sub bearing 9 Oldham mechanism 9a fixed-side key 9b orbiting-side key 9c Oldham mechanism annular portion
10 hermetic container 10a high-pressure space 10b glass terminal
11 refrigerating machine oil 12 discharge pipe 13 suction pipe 14 compression mechanism 15a first balance weight 15b second balance weight
100 scroll compressor 201 fixed scroll (related art) 201b spiral blade (related art) 201h distal end portion (related art) 201k bottom portion (related art)
201m chamfered portion (related art) 201n chamfered portion (related art) 202 orbiting scroll (related art) 202b spiral blade (related art) 202h distal end portion (related art) 202k bottom portion (related art) 202m chamfered portion (related art) 202n chamfered portion (related art)

1. A scroll compressor, comprising:
a fixed scroll including a first base plate portion and a first spiral blade provided to stand on one surface of the first base plate portion;
an orbiting scroll including a second base plate portion and a second spiral blade provided to stand on a surface of the second base plate portion opposite to the fixed scroll, and is configured to perform an orbiting motion with respect to the fixed scroll, the first spiral blade and the second spiral blade being in mesh with each other to form a compression chamber;
a first chamfered portion formed at each of both corner portions of a distal end portion of the first spiral blade;
a second chamfered portion formed at each of both corner portions of a distal end portion of the second spiral blade;
a third chamfered portion formed on each of both sides of a bottom portion of the first spiral blade, the third chamfered portion having a same shape as a shape of the second chamfered portion; and
a fourth chamfered portion formed on each of both sides of a bottom portion of the second spiral blade, the fourth chamfered portion having a same shape as a shape of the first chamfered portion,
a chamfer dimension of the first chamfered portion and a chamfer dimension of the second chamfered portion being different from each other.

2. The scroll compressor of claim 1, wherein each of the first chamfered portion, the second chamfered portion, the third chamfered portion, and the fourth chamfered portion has a straight chamfer shape in cross section.

3. The scroll compressor of claim 1, wherein each of the first chamfered portion, the second chamfered portion, the third chamfered portion, and the fourth chamfered portion has an arcuate chamfer shape in cross section.

4. (canceled)

5. The scroll compressor of claim 1,
wherein the fixed scroll and the orbiting scroll are made of materials having different hardness, and
wherein a chamfer dimension of one of the third chamfered portion and the fourth chamfered portion having higher hardness is larger, and a chamfer dimension of an other one having lower hardness is smaller.

6. The scroll compressor of claim 1,
wherein an expression of 0<{(Av1+Av2)/2}/Ac<1×10⁻⁴ is satisfied, under a state in which, among cross sections of the compression chamber passing through an orbiting center of the orbiting scroll and along a standing direction of the first spiral blade and the second spiral blade, a cross section having a largest sectional area is observed, where
a sectional area of a space formed between the first chamfered portion and the fourth chamfered portion under a state in which the first chamfered portion and the fourth chamfered portion are closest to each other is defined as Av1,
a sectional area of a space formed between the second chamfered portion and the third chamfered portion under a state in which the second chamfered portion and the third chamfered portion are closest to each other is defined as Av2, and
a sectional area of the compression chamber is defined as Ac.

7. The scroll compressor of claim 1,
wherein each of the chamfer dimensions is a size of a corresponding one of the chamfered portions.
